(19) United States
(12) Patent Application Publication
(10) Pub. No.: US 2011/0163604 A1
(43) Pub. Date: Jul. 7, 2011

(54) POWER SUPPLY CIRCUIT OF TERMINAL AND METHOD FOR SUPPLYING POWER USING THE SAME

(75) Inventors: Seung Su HONG, Suwon-si (KR); Seung Beom KANG, Suwon-si (KR)

(73) Assignee: SAMSUNG ELECTRONICS CO. LTD., Suwon-si (KR)

(21) Appl. No.: 12/985,639

(22) Filed: Jan. 6, 2011

(30) Foreign Application Priority Data
Jan. 6, 2010 (KR) 10-2010-0001004

(51) Int. Cl. H02J 9/00; H02J 7/00

(52) U.S. Cl. 307/66

(57) ABSTRACT

A power supply circuit and a power supply method using the same are provided. The power supply circuit includes a power interface to which power is supplied, a converter and a charging circuit connected to the power interface, a battery for receiving power from the charging circuit and for providing stored power to a system, the system for selectively receiving power from the battery or the system, a main switch disposed between the battery and the system for selectively interrupting the power of the battery to the system, and a control logic unit for switching the main switch according to presence of power supplied from the power interface.

### PRIORITY

This application claims the benefit under 35 U.S.C. §119(a) of a Korean patent application filed on Jan. 6, 2010 in the Korean Intellectual Property Office and assigned Serial No. 10-2010-0001004, the entire disclosure of which is hereby incorporated by reference.

### BACKGROUND OF THE INVENTION

1. Field of the Invention

The present invention relates to a power supply circuit of a terminal and a power supply method using the same. More particularly, the present invention relates to a power supply circuit of a terminal capable of stably supplying power to the terminal, and a power supply method using the same.

2. Description of the Related Art

In recent years, a portable terminal has become very popular based on its mobility. Furthermore, a mobile communication terminal may provide various functions including the transmitting and receiving of call information between parties as a main function. For example, a conventional portable terminal may provide an MP3 function corresponding to a file play function, and an image collection function corresponding to a digital camera capable of collecting images. Further, the conventional portable terminal supports a function capable of executing a mobile game or an Arcade game. Recently, portable terminal are provided with an extended area of a display device to support the foregoing various functions and also include high performance hardware to provide various functions. Meanwhile, a Personal Computer (PC) type terminal, for example, a notebook computer, provides an Internet access function but the size thereof tends to be significantly reduced. Such a Net-book computer, which refers to the reduced size of the notebook computer, is popular with many users. The portable terminal and PC type terminals have a tendency to be similar to each other regarding their functions and shapes.

The portable terminal and the PC type terminal use a single battery or multiple batteries having a predetermined capacity to support high performance. However, because shapes of the terminals differ from each other, they use different power supply circuits. Accordingly, there is a need for a power supply circuit and a power supply method that may supply power in common and optimally supply power to respective terminals in consideration of several variables including productivity regardless of power supply schemes of the portable terminal and the PC type terminal.

### SUMMARY OF THE INVENTION

An aspect of the present invention is to address the above-mentioned problems and/or disadvantages and to provide at least the advantages described below. Accordingly, an aspect of the present invention is to provide a power supply circuit of a terminal applicable to various terminals and capable of optimally supporting functions of respective terminals, and a power supply method using the same.

In accordance with an aspect of the present invention, a power supply circuit of a terminal is provided. The power supply circuit includes a power interface to which power is supplied, a converter and a charging circuit connected to the power interface, a battery for receiving power from the charging circuit and for providing stored power to a system, the system for selectively receiving power from the battery or the system, a main switch disposed between the battery and the system for selectively interrupting the power of the battery to the system, and a control logic unit for switching the main switch according to presence of power supplied from the power interface.

In accordance with another aspect of the present invention, a power supply method of a terminal is provided. The power supply method includes supplying power of a battery to a system, comparing a power voltage of an adapter with that of the battery when power of the adapter is supplied during the supplying of the battery power, and supplying the battery power to the system and isolating a battery when the power voltage of the adapter is greater than that of the battery.

In accordance with another aspect of the present invention, a power supply method of a terminal is provided. The power supply method includes supplying power of a battery to a system, and interrupting the power supply of the battery to the system and supplying external power to the system when the external power is supplied during supplying the battery power.

A power supply circuit of a terminal and a power supply method using the same according to an exemplary embodiment of the present invention may supply power to respective terminals irrespective of a type of a portable terminal and a PC type terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a power supply circuit of a terminal according to an exemplary embodiment of the present invention;

FIG. 2 is a circuit diagram illustrating a power supply circuit according to an exemplary embodiment of the present invention;

FIG. 3 is a circuit diagram illustrating a first operation of a power supply circuit of a terminal according to an exemplary embodiment of the present invention;

FIG. 4 is a circuit diagram illustrating a second operation of a power supply circuit of a terminal according to an exemplary embodiment of the present invention;

FIG. 5 is a circuit diagram illustrating a third operation of a power supply circuit of a terminal according to an exemplary embodiment of the present invention;

FIG. 6 is a circuit diagram illustrating a power supply circuit including an additional circuit for external power according to an exemplary embodiment of the present invention;

FIG. 7 is a circuit diagram illustrating a first operation of a power supply circuit including an additional circuit for external power according to an exemplary embodiment of the present invention; and

FIG. 8 is a circuit diagram illustrating a second operation of a power supply circuit including an additional circuit for external power according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

Terms or words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a power supply circuit and a power supply method using the same are described. In the following description, reference may be made to a specific type of terminal. However, it is to be understood that the power supply circuit and the power supply method described herein are applicable to various types of terminals including a portable terminal such as a mobile communication terminal, a Personal Digital Assistant (PDA), a Wireless Broadband (WiBro) terminal, a Portable Multimedia Player (PMP), a PC type terminal such as net book computer or notebook computer, and the like.

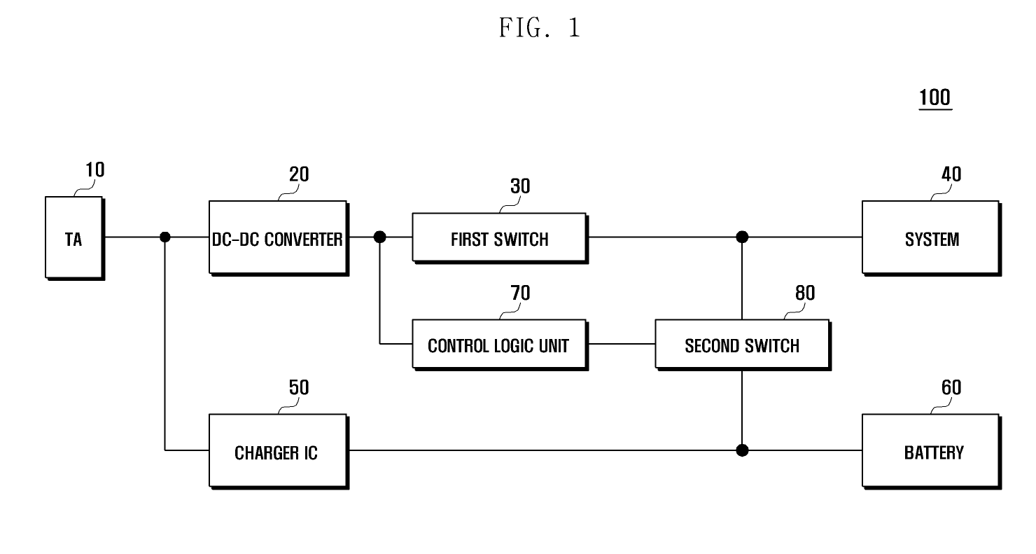

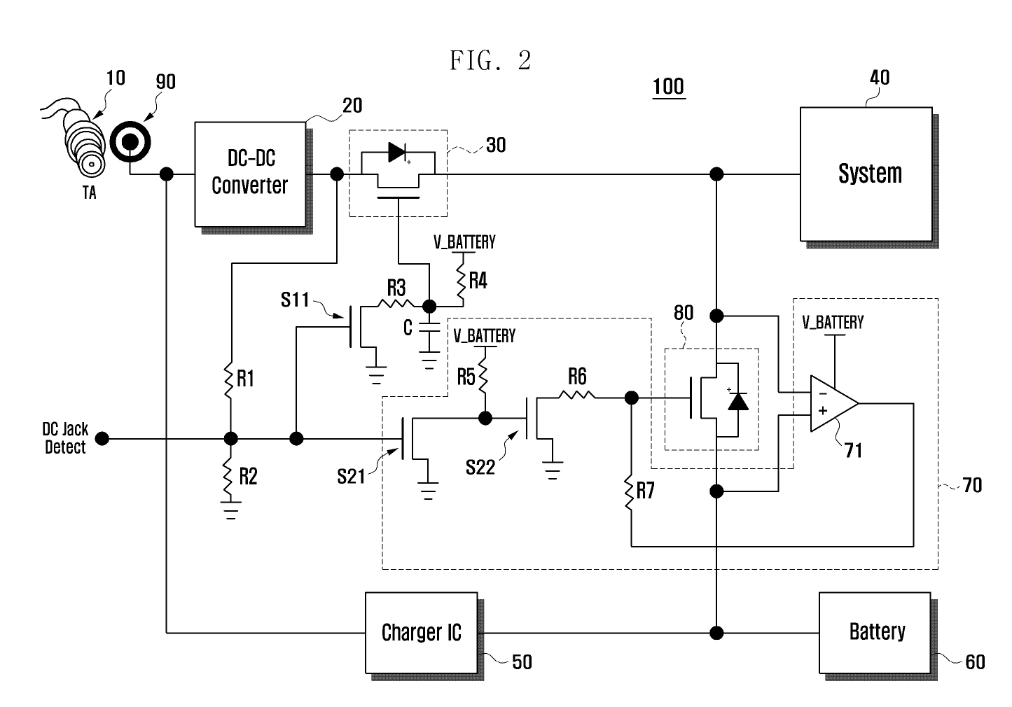

FIG. 1 is a block diagram illustrating a configuration of a power supply circuit of a terminal according to an exemplary embodiment of the present invention, and FIG. 2 is a circuit diagram illustrating a power supply circuit according to an exemplary embodiment of the present invention.

Referring to FIG. 1 and FIG. 2, the power supply circuit 100 of the present invention may include a DC-DC converter 20, a first switch 30, a system 40, a charger IC 50, a battery 60, a control logic unit 70, and a second switch 80. The first switch 30 connects with the DC-DC converter 20 and functions as an auxiliary switch and the second switch 80, disposed between the battery 60 and the system 40, functions as a main switch.

The power supply circuit 100 may also include a power interface 90 connecting with an adapter 10.

The power supply circuit 100 may control to supply power from the battery 60 to the system 40 when the adapter 10 is not connected. Conversely, when the adapter 10 is connected, the power supply circuit 100 may control to supply power from the adapter 10 to the system 40 and from the adapter 10 to charge the battery 60. Further, when the amount of power used in the system 40 is equal to or greater than a set value, the power supply circuit 100 may drive the system 40 to simultaneously use power of the adapter 10 and power of the battery 60. Accordingly, the power supply circuit 100 may stably support a system 40 and charge the battery according to connection of the adapter 10, and supply power at the time of using a specific function of the system 40. Hereinafter, respective structural elements of the power supply circuit 100 will be described in more detail.

The DC-DC converter 20 is disposed between the adapter 10 and the first switch 30, and converts power provided from the adapter 10 into power suitable for use by the system 40. For example, when the adapter 10 supplies power at 12V DC, the DC-DC converter 20 may convert the supplied power to a voltage that is appropriate for the system 40, for example 4.2V DC, and supply the converted voltage to the system 40 through the first switch 30.

The first switch 30 is disposed between the DC-DC converter 20 and the system 40, and selectively supplies the output power of the DC-DC converter 20 to the system 40. In more detail and with reference to FIG. 2, a gate terminal of the first switch 30 connects with an adapter detecting terminal, denoted as ‘DC Jack Detect,’ that detects connection of the adapter 10. A drain terminal of the first switch 30 connects with an output terminal of the DC-DC converter 20, and a source terminal of the first switch 30 connects with the system 40. The first switch 30 can be implemented by a P-channel, depletion mode Field Effect Transistor (FET). In this case, when power is not supplied to a gate terminal of the P-channel FET, it maintains an ‘on’ state. When a positive voltage of sufficient magnitude is supplied to the gate terminal of the P-channel, depletion mode FET, it is switched to an off state. Accordingly, when the adapter 10 is not connected, the first switch 30 maintains an off state. When the adapter 10 is connected, the first switch 30 is turned-on to transfer output power of the DC-DC converter 20 to the system 40. Further, the first switch 30 may prevent power of the battery 60 from being provided to the DC-DC converter 20 in a reverse direction.

Peripheral circuits of the first switch 30 will be explained in more detail. The power supply circuit 100 includes a first resistor R1, a second resistor R2, a first control switch S11, a third resistor R3, a fourth resistor R4, and a capacitor C. The first resistor R1 is connected between the DC Jack Detect terminal and a first node. The first node is provided between the DC-DC converter 20 and a drain terminal of the first switch 30. A first terminal of the second resistor R2 connects with the first resistor R1 while a second terminal of the second resistor R2 is connected to ground. The contact point between the first resistor R1 and the second resistor R2 connects with a gate terminal of the first control switch S11. The third resistor R3 connects with a drain terminal of the first control switch S11. A first terminal of the fourth resistor R4 connects with the third resistor R3 while a second terminal of the fourth resistor R4 connects with a battery voltage source V_BATTERY. The capacitor C is connected between a contact point between the third resistor R3 and the fourth resistor R4 and a ground terminal. A gate terminal of the first switch 30 connects with a contact point between the third resistor R3 and the fourth resistor R4.

The system 40 connects with a source terminal of the first switch 30, and a source terminal of a second switch 80 provided at the battery 60 side. The system 40 may selectively receive power provided from the DC-DC converter 20 or power provided from the battery 60 according to a turn-on state or a turn-off state of the first switch 30 and the second switch 80. The system 40 denotes a main control circuit of the terminal except for the power supply circuit. For example, when the terminal supports a mobile communication function, the system 40 may denote a modem. When the terminal is a PC type terminal, the system 40 may denote a central processing unit supporting an overall control of the terminal.

Furthermore, the system 40 may be any of various constructions for configuring the terminal. For example, the system 40 may be any of various function modules such as a radio frequency unit for forming a communication channel with a mobile communication network for supporting a mobile communication function, a radio frequency unit for supporting a web access function, an MP3 module for playing audio files, a camera module for collecting images, a near distance communication module for supporting a near distance communication function, an audio processing unit for processing audio related signals, a display unit for outputting predetermined images, a touch screen for supporting a touch function, and a vibration module for providing vibrations or other haptic output supported by the terminal. Accordingly, hereinafter, the system 40 can be understood as a function module using power provided from the power supply circuit 100 according to an arrangement or control of the control unit for supporting the foregoing various functions.

The charger IC 50 is disposed between the adapter 10 and a power interface 90 connecting with the adapter 10, and controls charging of the battery 60 using power provided from the adapter 10. When the adapter 10 supplies, for example, power at a voltage and current of 12V/2 A, the charger IC 50 may receive the supplied power, regulate the power to a voltage and current of 4.2V/2 A, and supply the regulated power of 4.2V/2 A to the battery 60, thereby charging the battery 60.

The battery 60 connects with the charger IC 50 and stores power provided from the charger IC 50. The battery 60 provides stored power to the system 40 through the second switch 80. The battery 60 can be manufactured in a secondary battery form and thus implemented to be charged and discharged a number of times. The battery 60 selectively supplies power to the system 40 according to the connection status of the adapter 10. When the adapter 10 is not connected with the power interface 90, namely, when no separate power is provided, the battery 60 provides stored power to the system 40 through the second switch 80. Alternatively, when the adapter 10 is connected with the power interface 90, the battery 60 stops providing power to the system 40. Instead, when the adapter 10 is connected with the power interface 90, the battery may perform a charging procedure using power provided from the charger IC 50. Alternatively, when the system 40 performs a function that consumes more power than a predetermined amount, the battery 60 may supply stored power to support a smooth operation of the system. The battery 60 may be implemented by a single cell structure.

The control logic unit 70 controls to turn-on or turn-off of the second switch 80 so as to supply power from the battery 60 to the system 40 or to disconnect power supplied from the battery 60 to the system 40. The control logic unit 70 may include a second control switch S21 connected to the DC Jack Detect terminal, a third control switch S22 connected to the second control switch S21, and a comparator 71 for comparing the powers of the second switch 80. In more detail, a gate terminal of the second control switch S21 may connect with the DC Jack Detect terminal, and a drain terminal thereof may connect with a gate terminal of the third control switch S22. Here, one terminal of a fifth resistor R5 is connected between a drain terminal of the second control switch S21 and a gate terminal of the third control switch S22, and another terminal thereof may connect with a battery voltage source V_BATTERY.

A drain terminal of the third control switch S22 connects with a gate terminal of the second switch 80 through a sixth resistor R6. Here, the second control switch S21 and the third control switch S22 can be configured by N-channel FETs. The source terminal and the drain terminal of the second switch 80 are input sources of the comparator 71, and the comparator 71 can be driven using a battery voltage source V_BATTERY. Further, an output of the comparator 71 may be fed back to the gate terminal of the second switch 80. In this case, an output of the comparator 71 is transferred to the gate terminal of the second switch 80 and the drain terminal of the third control switch S22.

The second switch 80 is disposed between the system 40 and the battery 60. A gate terminal of the second switch 80 connects with a drain terminal of the third control switch S22 in the control logic unit 70, and a gate terminal thereof connects with an output terminal of the comparator 71 through a seventh resistor R7. Moreover, a source terminal of the second switch 80 connects with a first input terminal (−) of the comparator 71, and a drain terminal thereof connects with a second input terminal (+) of the comparator 71. The second switch 80 can be configured by a P-channel FET. The second switch 80 may isolate the battery 60 from the system 40 according to control of the control logic unit 70, and supply power to the system according to voltage drop of power provided from the adapter 10.

Various circuit elements were described by way of example to control the first switch 30 and the second switch 80. However, the present invention is not limited to the foregoing circuit elements. That is, characteristics of circuit elements necessary for controlling operations of the first switch 30 and the second switch 80 in the power supply circuit 100 of the present invention can be changed according to a designer's intention or a terminal design environment. Further, at least one device can be added and removed to and from the circuit elements, respectively.

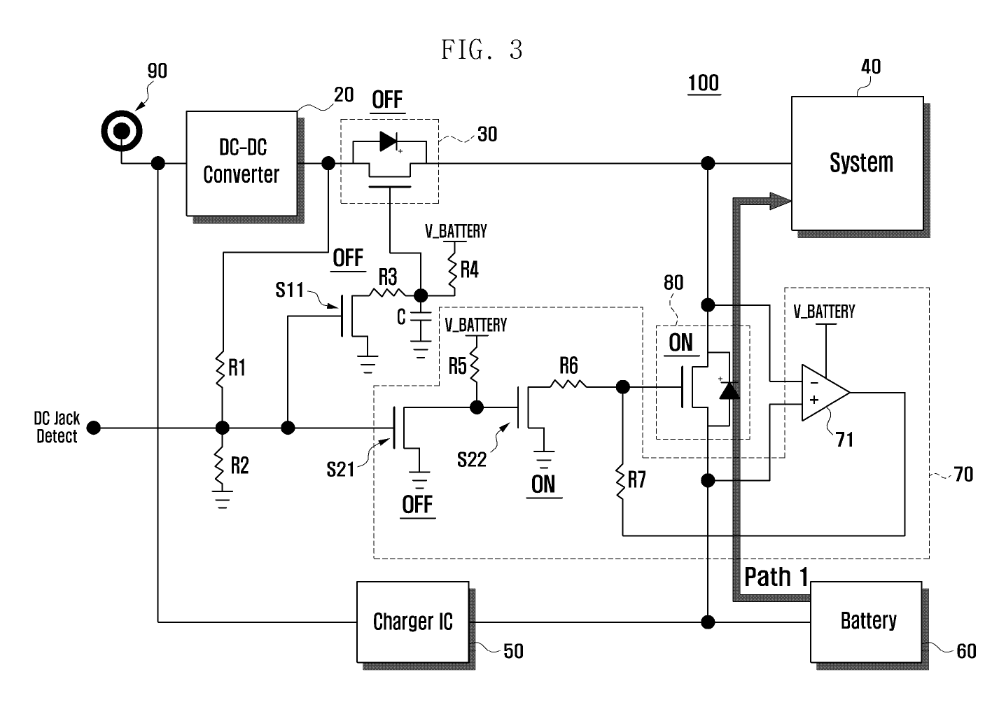

When the adapter 10 is not connected with the power interface 90, the power supply circuit 10 supplies power stored in the battery 60 to the system 40. Conversely, when the adapter 10 is connected to the power interface 90, the power supply circuit 100 may separately operate so as to supply power from the adapter 10 to the system 40 and to charge the battery 60. Further, when an amount of power used in the system 40 is equal to or larger than a predetermined value, for example, when a voltage provided from the adapter 10 is reduced to a value equal to or less than a voltage of the adapter 60, for example due to a rapid increase in current consumption, the power supply circuit 100 may supply power from the battery 60 to the system 40 to stably support the operation of the system 40. Operation of respective switches of the power supply circuit 100 due to various operations of the system 30 will be described with reference to FIG. 3 to FIG. 5.

Hereinafter, an exemplary operating method of a power supply circuit 100 is described below with reference to the accompanying drawings.

FIG. 3 is a circuit diagram illustrating a first operation of a power supply circuit of a terminal according to an exemplary embodiment of the present invention.

Referring to FIG. 3, because an adapter 10 is not connected with a power interface 90, a DC-DC converter 20 is not supplied power and thus does not output power. Accordingly, a first control switch S11 receives an output voltage of 0V from the DC-DC converter 20 divided by a first resistor R1 and a second resistor R2 through a gate terminal thereof and maintains an off state. When the first control switch S11 maintains the off state, a first switch 30, being a depletion mode P-channel type FET, enters an off state due to application of a battery voltage source V_BATTERY divided by a third resistor R3 and a fourth resistor R4 to the gate of the first switch 30. At this time, although the first switch 30 is switched to an on state, because there is no output power from the DC-DC converter 20, there is no power substantially supplied to a system 40 through the adapter 10.

Since there is no supply power, the second control switch S21, connected to the output of the DC-DC converter 20 at a gate terminal thereof, maintains an off state which is characteristic of an N-channel, enhancement mode FET. Accordingly, when the third control switch S22 receives a voltage from a battery voltage source V_BATTERY at a gate terminal thereof, it is switched to an on state. When the third control switch S22 is turned-on, the second switch 80 maintains an on state. A comparator 71 outputs a comparison value between a voltage applied to a source terminal of the second switch 80 and a voltage applied to a drain terminal of the second switch 80. In this case, because the comparison value is a voltage of a battery 60, the comparator 71 outputs a signal corresponding to the voltage of the battery 60. However, since the third control switch S22 maintains the on state, an output signal of the comparator 71 is transferred to a ground terminal through the third control switch S22. As a result, since there is no voltage applied to a gate terminal of the second switch 80, it maintains the on state for a P-channel type, depletion mode FET that is characteristic of the second switch 80. Accordingly, the power supply circuit 100 may form a Path 1 including the battery 60, the second switch 80, and the system 40, and supply power stored in the battery 60 to the system 40 through the second switch 80 based on the formed Path 1.

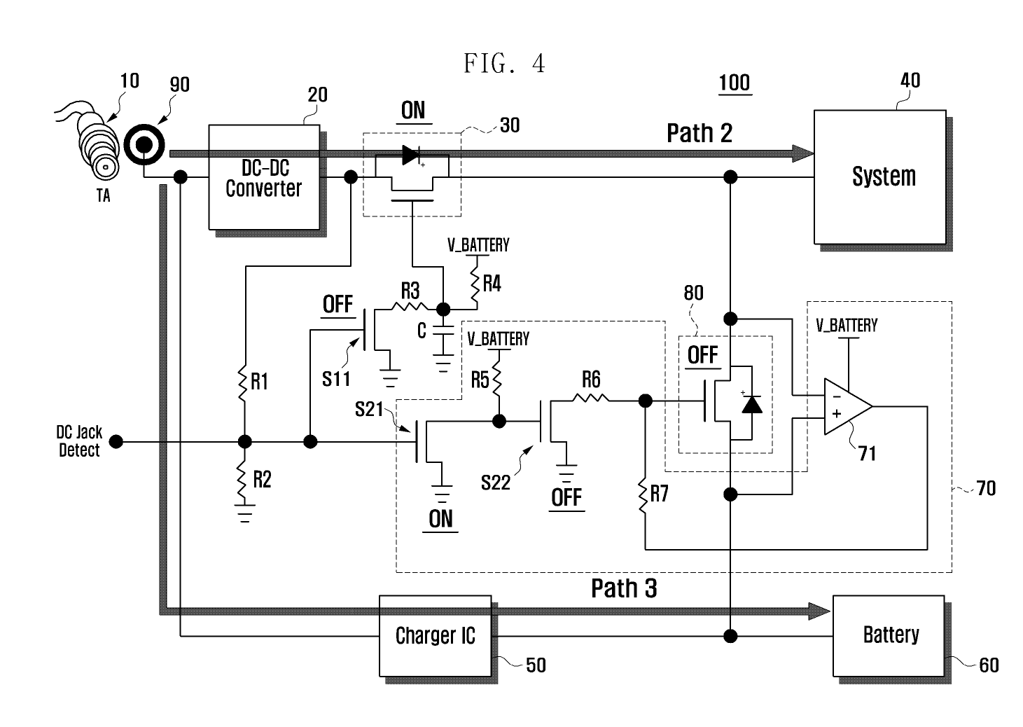

FIG. 4 is a circuit diagram illustrating a second operation of a power supply circuit of a terminal according to an exemplary embodiment of the present invention.

Referring to FIG. 4, an adapter 10 connects with a power interface 90 of a power supply circuit 100. Accordingly, the adapter 10 may supply power to a DC-DC converter 20 and a charging IC 50, respectively. At this time, the DC-DC converter 20 converts power provided from the adapter 10 into an appropriate level. For example, power supplied from the adapter 10 may be regulated to a level of 4.2V/3 A and provided to the system 40 through the first switch 30. At this time, the first switch 30 can be switched to an on state. In more detail, output power of the DC-DC converter 20 is divided by a first resistor R1 and a second resistor R2 such that the divided voltage can be supplied to a gate terminal of a first control switch S11.

Accordingly, the first control switch S11 can be switched from an off state to an on state. Consequently, a voltage of a battery voltage source V_BATTERY connected to a drain terminal of the first control switch S11 is provided to a ground terminal through the first control switch S11. As a result, since power of the battery voltage source V_BATTERY supplied to a gate terminal of the first switch 30 is removed, the first switch 30, being of a P-channel, enhancement type FET, can be switched from an off state to an on state. Consequently, the power supply circuit 100 may form a Path 2 including the adapter 10, the power interface 90, the DC-DC converter 20, the first switch 30, and the system 40, and supply power to the system 40 through the formed Path 2.

Meanwhile, power provided from the adapter 10 is also transferred to a charger IC 50, and the charger IC 50 may control power provided from the adapter 10 and provide it to the battery 60 according to a design. For example, when the adapter 10 supplies power of 12V/2 A, the charger IC 50 may control to regulate the received power to output a power of 4.2V/2 A and supply the controlled power as charging power. At this time, the power supply circuit 100 forms a Path 3 including the adapter 10, the power interface 90, the charger IC 50, and the battery 60, and charges the battery 60 through the formed Path 3.

When the adapter 10 supplies power, output power of the DC-DC converter 20 can be also supplied to a gate terminal of the second control switch S21 with a voltage divided by a first resistor R1 and a second resistor R2. Accordingly, the second control switch S21 can be switched from the off state to the on state according to supplied power. When the second control switch S21 is turned-on, a voltage of a battery voltage source V_BATTERY supplied between a drain terminal of the second control switch S21 and a gate terminal of the third control switch S22 is transferred to a ground terminal through the second control switch S21. Consequently, a gate terminal of the third control switch S22 may enter a low voltage state, which leads to an off state.

A voltage of a power supply in the system supplied by the DC-DC converter 20 through the first switch 30 is applied to a source terminal of the second switch 80, and a power voltage of the battery 60 is applied to a drain terminal of the second switch 80. In this case, when a voltage provided from the DC-DC converter 20 is greater than a voltage provided from the battery 60, for example, when the voltage provided from the DC-DC converter 20 is 4.2V and the voltage provided from the battery 60 is 3.7V, the comparator 71 outputs a difference between the two voltages and a signal corresponding thereto. The output signal of the comparator 71 is supplied to a gate terminal of the second switch 80. Accordingly, the second switch 80 having a P-channel type characteristic may enter an off state. When the second switch 80 enters the off state, power of the battery 60 is not supplied to the system 40, and accordingly the battery 60 may perform a charging procedure by power provided from the charger IC 50.

As described previously, when the adapter 10 connects with the power interface 90, the power supply circuit 100 may supply power to the system 40 and supply power to the battery 60 to stably charge the battery 60 and to supply power necessary for the operation of the system 40.

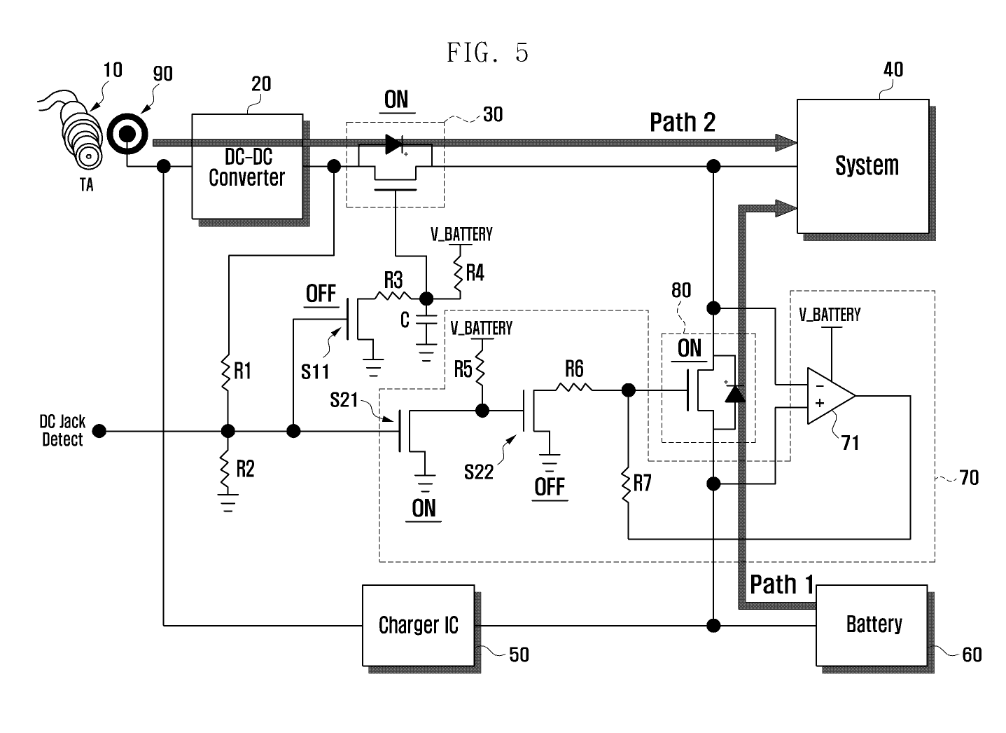

FIG. 5 is a circuit diagram illustrating a third operation of a power supply circuit of a terminal according to an exemplary embodiment of the present invention.

Referring to FIG. 5, an adapter 10 connects with a power interface 90 of a power supply circuit 100. Accordingly, the adapter 10 may transfer power to a DC-DC converter 20 and a charger IC 50, respectively. At this time, the DC-DC converter 20 converts power provided from the adapter 10 to desired power level, for example, a power level of 4.2V/3 A, and transfers the converted power to a system 40 through a first switch 30. In this case, the first switch 30 can be switched to an on state. Accordingly, the power supply circuit 100 may form a Path 2 including the adapter 10, the power interface 90, the DC-DC converter 20, the first switch 30, and the system 40, and supply the power to the system 40 through the formed Path 2.

When the adapter 10 supplies power, output power of the DC-DC converter 20 can also be supplied to a gate terminal of the second switch S21 with a voltage divided by a first resistor R1 and a second resistor R2. Consequently, the second control switch S21 may be switched from the off state to the on state. When the second control switch S21 is turned-on, a voltage of a battery voltage source V_BATTERY supplied between a drain terminal of the second control switch S21 and a gate terminal of the third control switch S22 is provided to a ground terminal through the second control switch S21. Accordingly, the gate terminal of the third control switch S22 may become a low voltage state that leads to an off state.

When a user operates various functions, current consumption of the system 40 can rapidly increase. As described above, when a large amount of current is rapidly consumed to operate functions of the system 40, a power voltage provided from the adapter 10 may rapidly drop. This reduces a voltage applied to a source terminal of the second switch 80. When the voltage applied to the source terminal of the second switch 80 drops, there may be no difference between a voltage applied to a source terminal of the second switch 80 and a voltage of the battery 60 applied to a drain terminal of the second switch 80, or the voltage applied to a source terminal of the second switch 80 may become less than the voltage of the battery 60 applied to a drain terminal of the second switch 80. Namely, a voltage of power provided from the DC-DC converter 20 may be identical with or less than a voltage provided from the battery 60. When the voltage of power from the DC-DC converter 20 drops to be identical with the voltage of power provided from the battery 60, there may be no difference of a comparison value output by the comparator 71.

As a result, because no signals are supplied to the gate terminal of the second switch 80, the second switch 80 having a P-channel type characteristic may enter an on state. When the second switch 80 is turned-on, power stored in the battery 60 is supplied to the system 40 through the second switch 80. Accordingly, a voltage drop larger than a predetermined value occurs due to rapid current consumption in the system 40, the power supply circuit 100 forms a Path 2 with the adapter 10, the power interface 90, the first switch 30, and the system 40; and a Path 1 with the battery 60, the second switch 80, and the system 40, and supplies both of power provided from the DC-DC converter 20 and power provided from the battery 60 to the system 40. Consequently, the system may support a more stable operation of a terminal using the supplied powers.

As illustrated earlier, when a power voltage provided from the DC-DC converter 20 drops more than a predetermined amount due to rapid current consumption of the system 40, the power supply circuit 100 may stably provide power in order to operate the functions of the system 40 using the power of the battery 60.

The following is an explanation of an exemplary operating method of a power supply circuit 100. The operation method of a power supply circuit 100 includes a procedure of blocking power supply of the battery to the system when external power is supplied through an external interface during power supply of the battery, and supplying the external power to the system. The exemplary operation method of a power supply circuit 100 includes blocking power supply of the power to the system according to the power supply of the adapter when power of a battery is supplied while supplying the external power. The operation method of a power supply circuit 100 may include maintaining blocking power supply of the battery to the system and charging the battery upon supplying the power of the battery.

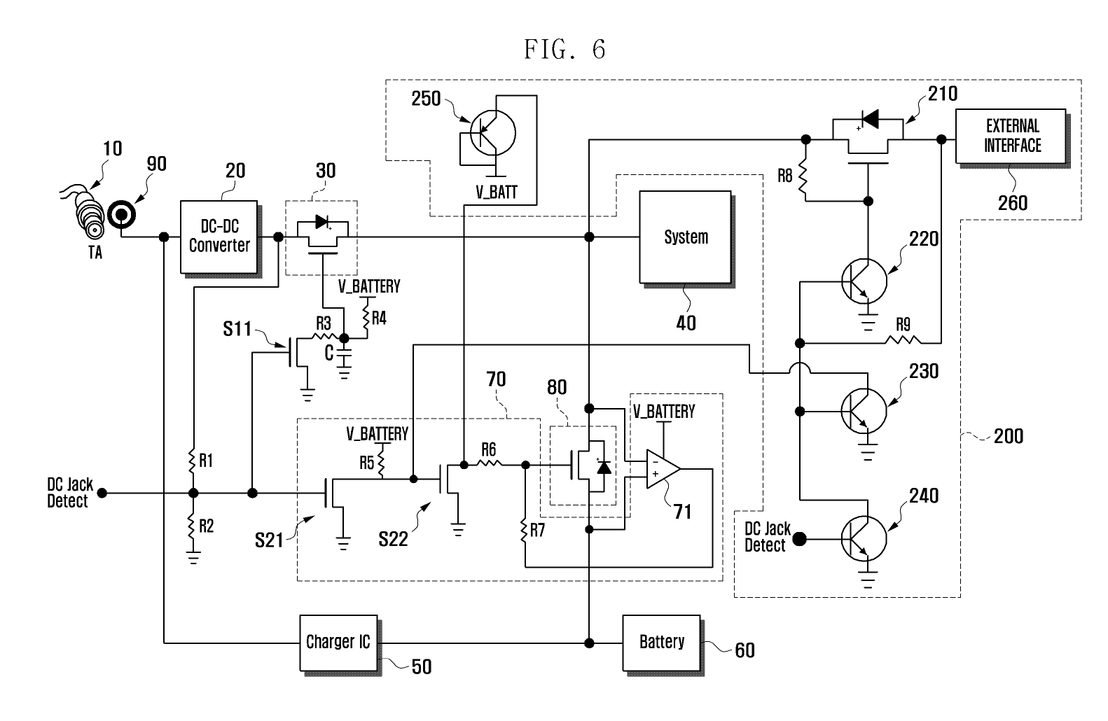

FIG. 6 is a circuit diagram illustrating a power supply circuit including an additional circuit for external power according to an exemplary embodiment of the present invention.

Referring to FIG. 6, the power supply circuit including an additional circuit for external power includes the power supply circuit 100 illustrated in FIG. 1 and FIG. 2 and an additional circuit 200 for external power. The power supply circuit 100 of FIG. 6 has the same construction as that of the power supply circuit shown in FIG. 1 and FIG. 2 described above, and thus the description thereof is appropriately omitted.

Hereinafter, the power supply circuit 100 having the additional circuit 200 for external power includes an external interface 260 for supplying external power to the system 40, and a switch 210 disposed between the system 40 and the external interface for selectively controlling supply of the external power. Further, the additional circuit 200 for external power may further include a circuit, namely, a fourth control switch 250 for supplying external power to a second switch 80, being the main switch, to turn-off the second switch 80 when external power is supplied to the system 40. Moreover, the additional circuit 200 for external power may further include a switch off circuit for external power blocking the switch 210 for external power when there is an output of the DC-DC converter 20.

Process power is described as an example of the external power. That is, an additional circuit 200 for external power may correspond to an additional circuit for a process. Accordingly, the switch for external power may correspond to a third switch 210 being a process switch. The switch off circuit for external power may further include a fifth control switch 220 for controlling the third switch 210, a sixth control switch 230, a seventh control switch 240, and signal lines connected between corresponding switches and the power supply circuit 100. Here, an addition circuit for a process has been described as an example of the additional circuit 200 for external power. However, the present invention is not limited thereto. Namely, the additional circuit 200 for external power may be used as an additional circuit for a process and be used in various forms according to a terminal designer's intention.

The additional circuit 200 for a process may include a third switch 210 connecting the external interface 260 to the system 40, a fourth control switch 250 for controlling the second switch 80, a fifth control switch 220 controlling connection of the adapter 10, a sixth control switch 230, and a seventh control switch 240. Here, the third switch 210 and the fourth control switch 250 can be implemented by a P-channel type switch, and the fifth control switch 220, the sixth control switch 230, and the seventh control switch 240 can be implemented by an N-channel type switch. However, the present invention is not limited thereto. That is, the switches can be implemented by various types according to a designer's intention or a terminal environment including a corresponding circuit. Here, the external interface 260 can supply various power and data to test the system. Further, the external interface 260 can be implemented by a circuit arrangement, for example, an external input/output port form of a terminal capable of supplying power and data to a system 40 of the terminal.

A layout of respective switches in the additional circuit for a process is now explained in more detail. The third switch 210 is disposed between the external interface 260 and the system 40, and may selectively supply power and signals of various testing devices connected to the external interface 260 to the system 40. The third switch 210 may include an eighth resistor R8 connecting a gate terminal to a source terminal. A base terminal of the fourth control switch 250 and an emitter terminal of the fourth control switch 250 connect with a process power source V_BATT. Moreover, a collector terminal of the fourth control switch 250 is connected between a drain terminal of the third control switch S22 and a gate terminal of the second switch 80. Accordingly, while a voltage of the process power source V_BATT is supplied, the fourth control switch 250 maintains an on state. Consequently, the voltage of the process power source V_BATT may be supplied to a gate terminal of the second switch 80. As a result, when a voltage of the process power source V_BATT is supplied, the fourth control switch 250 may control the second switch 80 to continuously maintain an off state, thereby preventing power of the battery 60 from being supplied to the system 40. Accordingly, the power supply circuit 100 of the present invention may supply the voltage of the process power source V_BATT in various forms regardless of power of the battery 60.

Further, a collector terminal of the fifth control switch 220 connects with a gate terminal of the third switch 210, and an emitter terminal thereof connects with a ground terminal. A base terminal of the fifth control switch 220 can be connected between the external interface 260 and a ninth resistor R9. A base terminal of the sixth switch 230 can be connected between the external interface 260 and the ninth resistor R9 in the same manner as in the fifth control switch 220. A collector terminal of the sixth control switch 230 is connected between a drain terminal of the second control switch S21 and a gate terminal of the third control switch S22, and an emitter terminal thereof connects with a ground terminal. A base terminal of the seventh control switch 240 may connect with an adapter detecting terminal DC Jack Detect, and a collector terminal thereof may connect with the external interface 260 with the ninth resistor R9 between. An emitter terminal of the seventh control switch 240 may connect with a ground terminal.

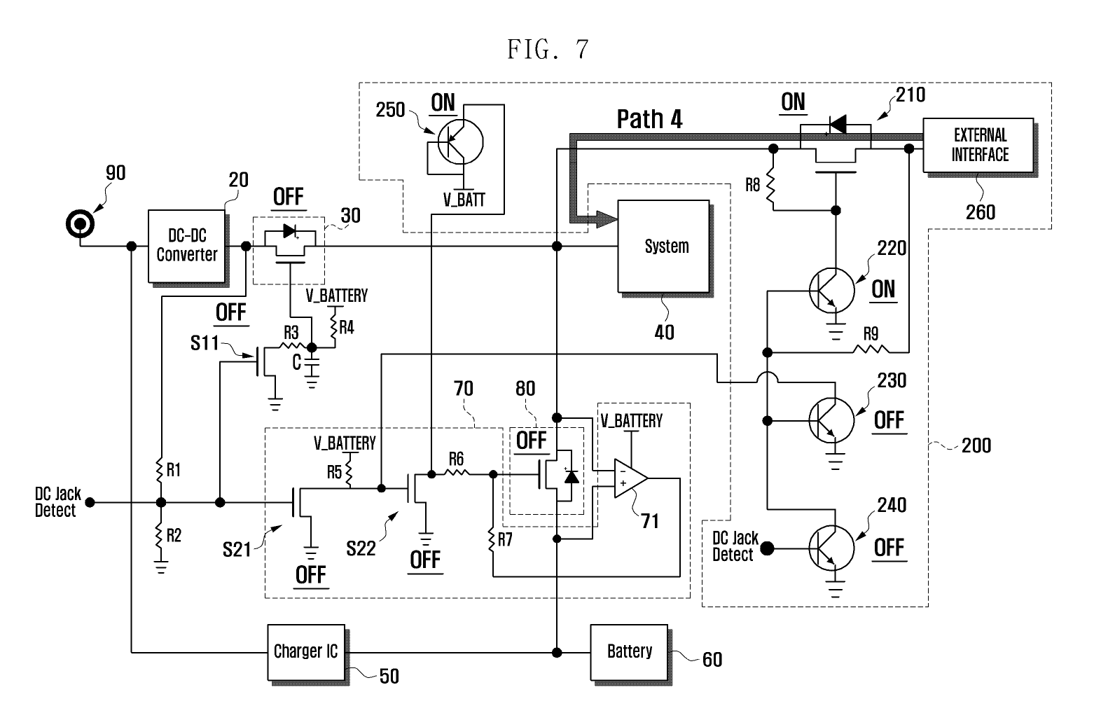

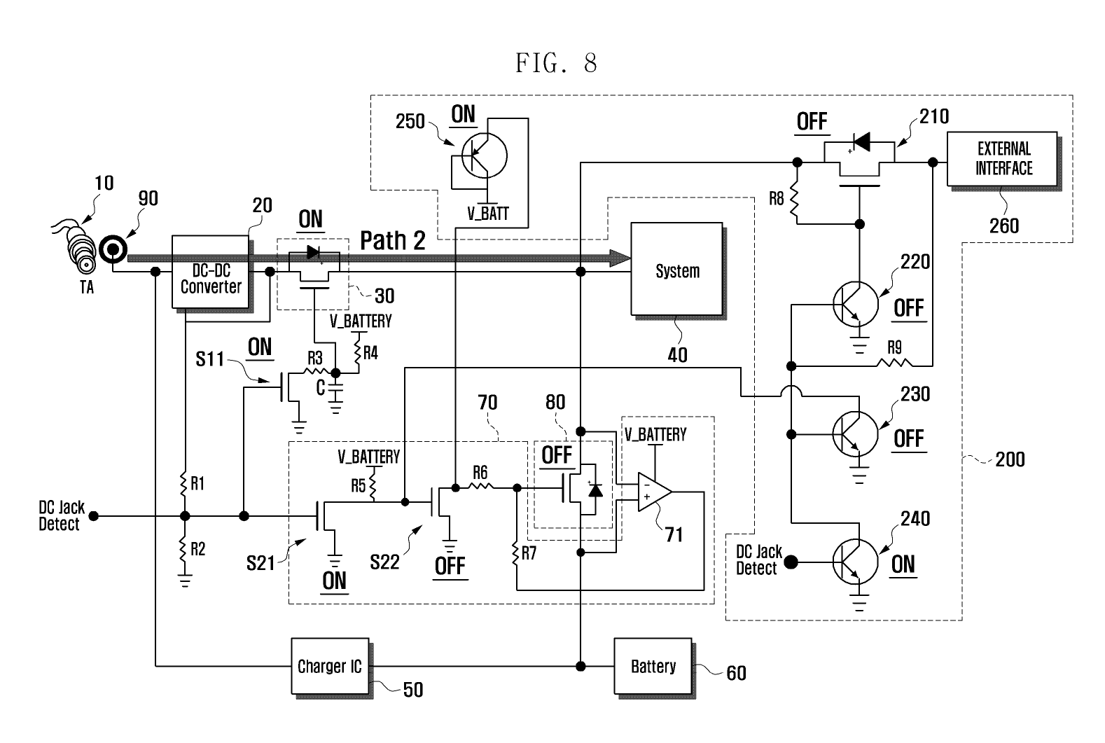

When a voltage of the process power source V_BATT is supplied to the system in a state that only a battery 60 is connected, the power supply circuit 100 with the additional circuit 200 for a process having the construction mentioned above interrupts a Path 1 between the battery 60 and the system 40, and supplies only the voltage of the process power source V_BATT to the system 40. When the adapter 10 is connected simultaneously with supply of a voltage from the process power source V_BATT, the power supply circuit 100 with the additional circuit 200 for a process may interrupt all power circuits for a process and control the system 40 to be operated by only power provided from the adapter 10 in order to prevent a short circuit between the adapter 10 and process power. An operation of the power supply circuit 100 with the additional circuit 200 for a process having the construction mentioned above will be described with reference to FIG. 7 and FIG. 8 below.

FIG. 7 is a circuit diagram illustrating a first operation of a power supply circuit including an additional circuit for external power according to an exemplary embodiment of the present invention.

Referring to FIG. 7, when a battery 60 is mounted in the terminal and power exists in the battery 60, the battery 60 supplies stored power to the system 40 through a second switch 80. At this time, a voltage from a process power source V_BATT may be supplied through an external interface 260 included in the additional circuit 200 for a process. Accordingly, the power supply circuit 100 may change the second switch 80 to be switched to an off state to interrupt power supplied from the battery 60 and to supply the voltage of a process power source V_BATT from the external interface 260 to the system 40.

In more detail, since there is no output of the DC-DC converter 20 in a state that the adapter 10 is not connected, the first control switch S11 and the second switch 80 receiving output power of the DC-DC converter 20 may enter an off state. Further, when the first control switch S11 is turned-off, the first switch 30 of a P-channel type receiving power of the battery voltage source V_BATTERY at a gate terminal thereof maintains an off state.

When power provided from the external interface 260 is applied to respective base terminals of the fifth control switch 220 and the sixth control switch 230, they maintain an on state. Accordingly, as power of the battery voltage source V_BATTERY designed to be supplied to the third control switch S22 is provided to a ground terminal through the sixth control switch 230, the third control switch S22 may be turned-off. Furthermore, because a voltage of a process power source V_BATT is not supplied to a base terminal of the fourth control switch 250 of a P-channel type, the fourth control switch 250 maintains an on state, and accordingly the voltage of a process power source V_BATT connected to an emitter terminal of the fourth control switch 250 is supplied to a gate terminal of the second switch 80. Accordingly, the second switch 80 can be switched to an off state due to supplied power.

The external interface 260 enters an on state due to the voltage of a process power source V_BATT provided through the fifth control switch 200 connected to a base terminal or the external interface 260. Accordingly, a third switch 210 of a P-channel type is turned-on to supply the voltage of the process power source V_BATT to the system 40. Namely, the power supply circuit 100 may turn-off the second switch 80 and turn-on the third switch 210 to form a Path 4 including the process power source V_BATT, the external interface 260, the third switch 210, and the system 40, and supply the process power source V_BATT to the system 40 through the formed Path 4. Moreover, because the adapter 10 is not connected, the seventh switch 240 maintains an off state.

As illustrated previously, the power supply circuit 100 including an additional circuit 200 for a process according to an exemplary embodiment of the present invention may interrupt power of the battery 60 at the time of supplying the voltage of the process power source V_BATT to perform various testing procedures necessary during a process procedure irrespective of the power of the battery 60.

FIG. 8 is a circuit diagram illustrating a second operation a power supply circuit including an additional circuit for external power according to an exemplary embodiment of the present invention.

Referring to FIG. 8, when the adapter 10 is connected to a power interface 90 of the power supply circuit 100 to supply power while a voltage of a process power source V_BATT is supplied through the external interface 260, the power supply circuit may turn-off the third switch 210 to interrupt the voltage supply from the process power source V_BATT to the system 40.

In more detail, when the adapter 10 connects with the power interface 90, the power supply circuit 100 supplies power of the battery 10 to the DC-DC converter 20 and the charger IC 50. Accordingly, the DC-DC converter 20 may convert the power of the battery 10 into power having predetermined voltage and current levels according to a designed circuit, and provide the converted power to the system 40 through the first switch 30. At this time, an output voltage of the DC-DC converter 20 is divided by a first resistor R1 and a second resistor R2, and the divided voltage can be supplied to the first control switch S11 and the second control switch S21. Accordingly, the first control switch S11 and the second control switch S21 are turned-on. Consequently, power of the battery voltage source V_BATTERY connected to a drain terminal of the first control switch S11 is provided to a ground terminal through the first control switch S11, and accordingly the first switch 30 of a P-channel type may be turned-on to supply the output of the DC-DC converter 20 to the system 40. That is, the power supply circuit 10 may form a Path 2 with the adapter 10, the power interface 90, the DC-DC converter 20, the first switch 30, and the system 40, and supply the power of the battery 10 to the system 40 through the formed Path 2.

Furthermore, since the second control switch S21 is turned-on, power of the battery voltage source V_BATTERY connected to a drain terminal of the second control switch S21 is provided to a ground terminal through the second control switch S21. Accordingly, because the power of the battery voltage source V_BATTERY is not supplied to the third control switch S22, the third control switch S22 may enter an off state. In addition, the second switch 80 may enter an off state according to an output of a comparator 71 occurring due to the adapter 10 supplying power greater than that of the battery 60. In this case, the power of the DC-DC converter 20 is supplied to a source terminal of the second switch 80.

As described above, the fourth control switch 250 of the additional circuit 200 for a process maintains the on state, and a seventh control switch 240 is switched to an on state. In this case, a signal of an adapter detecting terminal DC Jack Detect is supplied to the seventh control switch 240. Due to switching of the seventh control switch 240 to the on state, power of the process power source V_BATT supplied from the external interface 260 is provided to a ground terminal through a ninth resistor R9 and the seventh control switch 240. Accordingly, the power of the process power source V_BATT supplied to base terminals of the fifth control switch 220 and the sixth control switch 230 may be removed to turn-off the fifth control switch 220 and the sixth control switch 230. When the fifth control switch 220 is turned-off, the third switch 210 enters an off state because voltages of the gate terminal and the source terminal are the same as each other due to a signal line including an eighth resistor R8. Accordingly, the third switch 210 interrupts power supply of the process power source V_BATT through the external interface 260. Here, when the adapter 10 supplies power, the charger IC 50 may control charging of the battery 60 using the supplied power of the adapter 10.

The foregoing exemplary embodiments illustrate the fourth control switch 250, the fifth control switch 220, the sixth control switch 230, and the seventh control switch 240 in the form of a transistor, and describe signal flow thereby. However, the present invention is not limited thereto. Namely, a semiconductor type, for example, an FET capable of providing equivalent signal flow for the fourth control switch 250, the fifth control switch 220, the sixth control switch 230, and the seventh control switch 240 can be substituted due to various reasons such as a designer's intention or an environment of a terminal. In this case, a P-type FET may be substituted for the fourth control switch 250, and an N-type FET may be substituted for the fifth control switch 220, the sixth control switch 230, and the seventh control switch 240.

As described above, when power is supplied by connecting to the adapter 10, the power supply circuit 100 controls the respective switches disposed in signal lines being supplied with process power source V_BATT so that the process power source V_BATT may not be supplied to the system 40. Accordingly, it can support the power source of the adapter 10 and the process power source V_BATT not to be shorted.

Although exemplary embodiments of the present invention have been described hereinabove, it should be clearly understood that many variations and modifications of the basic inventive concepts herein taught which may appear to those skilled in the present art will still fall within the spirit and scope of the present invention, as defined in the appended claims.

What is claimed is:

1. A power supply circuit of a terminal, the circuit comprising:
a power interface to which power is supplied;
a converter and a charging circuit connected to the power interface;
a battery for receiving power from the charging circuit and for providing stored power to a system;
a system for selectively receiving power from the battery or the system;
a main switch disposed between the battery and the system for selectively interrupting the power of the battery to the system; and
a control logic unit for switching the main switch according to the presence of power supplied from the power interface.

2. The circuit of claim 1, wherein the control logic unit comprises a comparator for comparing a first power supplied from the converter to the system with a second power supplied from the battery to the system, and for supplying a difference between the first power and the second power or a signal corresponding to the difference to the main switch.

3. The circuit of claim 1, further comprising an auxiliary switch disposed between the converter and the system for selectively interrupting the supply of the power from the converter.

4. The circuit of claim 3, further comprising a first control switch connected to the auxiliary switch to be switched according to an output of the converter,
wherein the battery provides a voltage for controlling the switching of the auxiliary switch according switching of the first control switch.

5. The circuit of claim 1, further comprising:
a second control switch for switching according to an output of the converter; and
a third control switch, for switching according to a voltage supplied from the battery according to switching of the second control switch, connected to the main switch.

6. The circuit of claim 1, wherein the main switch is switched off to isolate the battery when an output of the converter exists.

7. The circuit of claim 1, wherein the main switch is switched on under control of the control logic unit when an output voltage of the converter becomes equal to or less than a voltage of the battery voltage to supply the power of the battery to the system.

8. The circuit of claim 1, further comprising an additional circuit for supplying external power for testing the system,
wherein the additional circuit for external power comprises:
an external interface for supplying the external power to the system; and
a switch, disposed between the system and the external interface, for selectively controlling supply of the external power.

9. The circuit of claim 8, wherein the additional circuit further comprises a circuit for supplying the external power to the main switch to turn-off the main switch when the external power is supplied to the system.

10. The circuit of claim 8, wherein the additional circuit further comprises a switch off circuit for external power for interrupting the switch for external power when the output of the converter exists.

11. A power supply method of a terminal, the method comprising:
supplying power of a battery to a system;
comparing a voltage of the adapter power with a voltage of the battery power when the power of an adapter is supplied during the supplying of the battery power; and
supplying the adapter power to the system and isolating the battery when the voltage of the adapter power is greater than that of the battery power.

12. The method of claim 11, further comprising:
charging the battery with the adapter power.

13. The method of claim 11, further comprising:
supplying the battery power to the system together with the adapter power when the power voltage of the adapter is equal to or less than the voltage of the battery.

14. A power supply method of a terminal, the method comprising:
supplying power of a battery to a system; and
interrupting the power supply of the battery to the system and supplying external power to the system when the external power is supplied during the supply of the battery power.

15. The method of claim 14, further comprising:
supplying power of a battery when the external power is supplied; and
interrupting the supply of the external power to the system according to a power supply of an adapter.

16. The method of claim 15, further comprising:
comparing a voltage of the power supplied from the adapter with a voltage of the battery; and
supplying the battery power to the system together with the adapter power when the power voltage of the adapter is equal to or less than the voltage of the battery.

17. The method of claim 16, further comprising:
charging the battery with the adapter power.

18. The method of claim 15, further comprising:
maintaining the interrupting of the power supply of the battery to the system.

19. The method of claim 15, further comprising:
charging the battery upon supplying the power of the battery.
